(19) United States
(12) Patent Application Publication
(10) Pub. No.: US 2007/0151523 A1
(43) Pub. Date: Jul. 5, 2007

(54) Fantasia aquarium

(76) Inventors: Nick Han Suteerawanit, Sun Valley, CA (US); Preecha Sanguanvichaikul, Sun Valley, CA (US)

Correspondence Address: Raymond Y. Chan, 108 N. Ynez Ave., #128, Monterey Park, CA, 91754, US

(21) Appl. No.: 11/322,691

(22) Filed: Dec. 30, 2005

(51) Int. Cl. A01K 63/00

(52) U.S. Cl. 119/253

(57) ABSTRACT

A fantasia aquarium, comprising a characterizing building and a plurality of see-through sealing walls, such that the aquarium provides a decorative function not only when it contains living water creatures within the water container, but also when the container contains no water creatures, allowing the aquarium to be appreciated as a piece of art-work, such that when the aquarium is empty for any reason, it can still act as a piece of decoration itself to decorate a room that conventional aquariums cannot. The fantasia aquarium also allows a viewer or a manufacturer to show off their artistic talents since the characterizing building can be decorated in many different ways, such as attaching paintings or figures onto the frame and integrally forming the decorations with the frame.

### BACKGROUND OF THE PRESENT INVENTION

1. Field of Invention

The present invention relates to an aquarium, and more particularly to a self-decorative water animal tank which has a characterizing building and a water tank having, such that the fantasia aquarium is decorative not only when it contains living animals within the water tank, but also when the panel is empty, allowing an aquarium itself to be appreciated as a piece of art-work, such that when the fantasia aquarium is empty for any reason, it can act as a piece of decoration itself.

2. Description of Related Arts

Most conventional aquariums are simply a transparent water tank made with glass panels, creating a water cavity to contain water and water creatures such as fish, and other related decorations such as sea weed and stones.

Some fancier ones would perhaps include a top and a bottom rim, so as to provide a better appearance to a plain aquarium or fish tank, or some would vary in shape, so as to give the fish tank a less boring shape. Some smaller aquariums are in the form of cups or bowls. However, most aquariums are boring and plain.

A plain fish tank of course can serve the fundamental function of holding water tightly within the tank, so as to keep fish alive in the tank. People can also appreciate the fish in the tank through the fish tank, such that the fish tank with fish would serve as a decoration to a home, and add liveliness to the home.

The sole purpose of people buying a fish tank or an aquarium is to have fish put inside the fish tank. As a result, very seldom would people put emphasis on the fish tanks themselves. Which means that the tank themselves cannot be appreciated without fish being put inside.

This would be fine until one day, for example, the owner does not want to keep fish anymore. The tank is then empty. Leaving empty a small tank is easy since one can simply put away the empty tank without thinking too much about it. But still, it does take up some space. Leaving empty a bigger tank, however, might create problems. The reason is that some people might not have the necessary storage space and leaving the big tank empty in the sitting room is not very presentable.

In view of the above drawbacks of and the problems brought on by conventional fish tanks and aquariums, a better type of fish tanks and aquariums have to be provided so as to not only provide a home for the fish so as to decorate the home, but also act as a decoration of a home even without the presence of any fish or water creatures put inside.

### SUMMARY OF THE PRESENT INVENTION

A main object of the present invention is to provide a fantasia aquarium, comprises a characterizing building, and at least one panel to sealingly form a container having a water cavity, wherein the container is to be placed within the characterizing building.

Another object of the present invention is to provide a fantasia aquarium, wherein the characterizing building allows the fantasia aquarium to be a piece of decoration or art work even when the water cavity does not contain any water or water creatures.

Another object of the present invention is to provide a fantasia aquarium, wherein a decoration on the characterizing building is capable of being simple and flat paintings or pictures.

Another object of the present invention is to provide a fantasia aquarium, wherein the decoration on the characterizing building is capable of protruding outwardly from the frame, so as to create a 3D effect, providing more liveliness.

Another object of the present invention is to provide a fantasia aquarium, wherein the decoration on the characterizing building allows the fantasia aquarium to have a theme, creating more decorative effect to the fantasia aquarium.

Another object of the present invention is to provide a fantasia aquarium, wherein the decoration on the characterizing building is replaceable, such that the decoration can be changed according to the occasion, season, festival and/or the viewer's desire.

Another object of the present invention is to provide a fantasia aquarium, wherein the container can be integrally formed on the frame, such that there are no detachable parts.

Another object of the present invention is to provide a fantasia aquarium, wherein the container can be detachably formed with the frame, such that the container can be taken out from the frame for cleaning.

Another object of the present invention is to provide a fantasia aquarium, wherein the frame is capable of being in different shapes, so as to provide more flexibility for the designer of such aquarium.

Accordingly, in order to accomplish the above objects, the present invention provides a fantasia aquarium, comprising:

a characterizing building defining a container site therewithin; and

a container comprises at least one panel sealedy forming a water cavity, wherein the container is adapted for fitting onto the container site of the characterizing building.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the fantasia aquarium according to a preferred embodiment of the present invention.

FIG. 2 is a cross-sectional view of the fantasia aquarium according to the above preferred embodiment of the present invention.

FIG. 3 is a perspective view of the fantasia aquarium according to an alternative embodiment of the present invention.

FIG. 4 is a cross-sectional view of the fantasia aquarium according to the above alternative embodiment of the present invention.

FIG. 5 is an exploded view of the fantasia aquarium according to the above alternative embodiment of the present invention.

### DETAILED DESCRIPTION OF THE PREFERRED EMBODIMENT

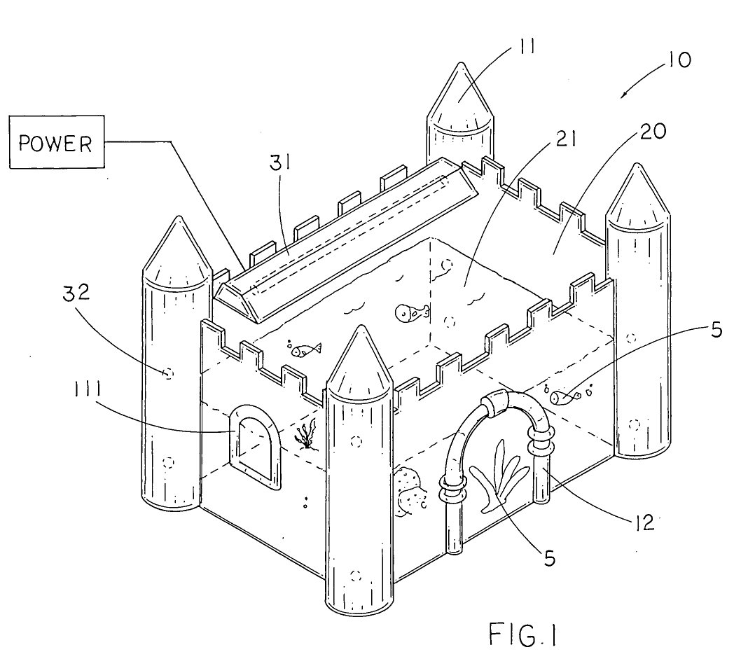

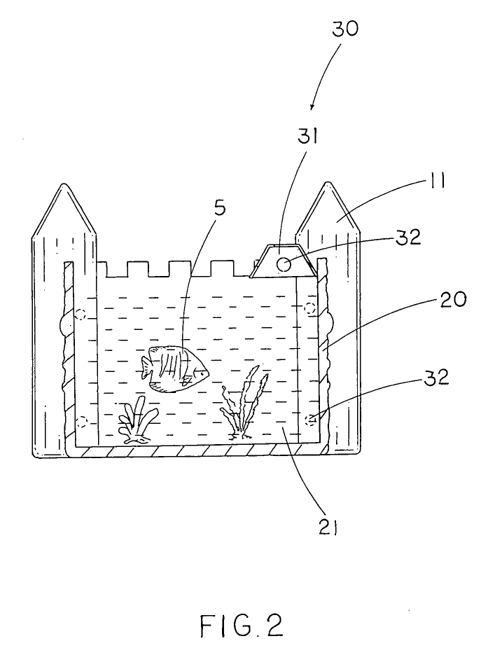

Referring to FIG. 1 to FIG. 2 of the drawings, a fantasia aquarium according to a preferred embodiment of the present invention is illustrated, wherein the container comprises a characterizing building 10, and a plurality of see-through sealing walls 20.

Referring to FIG. 1A of the drawings, the characterizing building 10 comprises a displaying frame 11 and a 3-D figuring body 12. The displaying frame 11 has a plurality of viewing windows 111 allowing a viewer to look into the fantasia aquarium, so as to see an aquatic being 5 within the fantasia aquarium.

The characterizing building 10 allows the fantasia aquarium to be in the shape or appearance of different building structures, such as a palace or a house, meaning that the fantasia aquarium is no longer any ordinary aquarium or fish tanks where fish are simply being kept in a boring and tasteless fish tank.

When the 3-D figuring body 12 is incorporated on the displaying frame 11, meaning that the characterizing building 10 of the fantasia aquarium has an appearance of a building structure painted on the displaying frame 11, the characterizing building 10 allows a viewer to imagine or picture their fish being kept, for example, in a palace. This is particularly suitable for kids and people who really love aquatic beings, so as to allow them to imagine that the fish is being kept in a home, just like human beings living in a comfy home.

It is worth mentioning that, even when empty, the aquarium can be displayed as an art piece, because of its well decorated displaying frame 11. As a result, even when the aquarium is left empty, meaning that no aquatic beings are placed in the fantasia aquarium, it may still be appreciated as a decoration placed in the house.

The 3-D figuring body 12 is three-dimensional and outwardly protruding from the displaying frame 11. The 3-D figuring body serves the purpose of creating a 3-D figuring contour of the characterizing building 10.

The plurality of see-through sealing walls 20 are sealedly provided on the viewing windows 111 of the displaying frame 11 respectively, so as to form an aqua reservoir 21 within the sealing walls 20.

The characterizing building 10 is custom-shaped for enhancing a fantasizing vision effect to create a virtual fantasia environment of said aqua reservoir 21 for the aquatic-being physically living in the aqua reservoir 21.

The fantasia aquarium allows a lot of rooms for creativity since the it can be made into different shapes and structures, allowing an owner to show off his/her personal taste. It can also help enhancing the decorations already in the house, allowing an owner who does not like conventional and plain fish tanks to have a change to keep fish and other aquatic beings in his/her house.

It can be seen that the present invention can allow owners or manufacturers to customize their own aquariums, so as to blend in or enhance the interior design of their homes, or to put an accent to their homes.

According to the preferred embodiment of the present invention, the sealing walls 20 are integrally provided at the display frame 11 to form a one-piece integral structure of the characterizing building 10. This would provide an integrated feeling to the fantasia aquarium, such that the aquarium looks realistically similar to the building structure it is representing.

Also, the 3-D figuring body 12 is integrally protruded from the displaying frame 11. The reason is that an integral sculpturing structure will be formed with the displaying frame 11, so as to also produce a more realistic visual effect of the building structure, such that the aquarium would appear to be a one-piece, continuous, realistic, carefully design and manufactured art work.

As an example, in order to provide a Christmassy feeling to the viewers, the displaying frame 11 of the characterizing building can be of a house, with chimneys, windows, and the 3-D figuring body 12 which has a Santa Clause figure, snow, reindeers and so forth on the displaying frame 11. As can be imagined, the fantasia aquarium under the present invention itself can be appreciated as a piece of art, whether or not there are aquatic beings 5 therewithin.

It is worth mentioning that although the fantasia aquarium can be made of all suitable material, according to the preferred embodiment of the present invention, the characterizing building 10 and the sealing walls 20 are made from a plexiglass, which is transparent, durable, unbreakable, such that the fantasia aquarium is see-through but yet not easy to be damaged.

The fantasia aquarium can therefore better sustain impacts during transportation than conventional aquariums and while installed. Furthermore, since it will not break as easily as conventional glass type aquariums, they are safer than conventional glass type aquariums to be installed at home, especially those with children living therein, since it prevents glass breaking and injuries even when the children decide to tamper with the aquarium.

In order to provide a better aquatic condition, as well as a better visual effect for the aquatic beings 5, the fantasia aquarium further comprises a light enhancing arrangement 30. The light enhancing arrangement 30 comprises a light housing 31 and at least a light source 32. The light housing 31 is supported by the displaying frame 11 and the light source 32 is received in the light housing 31 to illuminate the aqua reservoir 21 and to generate a light effect on the 3-D figuring body through the displaying frame 11.

The light enhancing arrangement 30 is provided for creating a light effect to the fantasia aquarium, through directly shining the light into the aqua reservoir 21 and onto the fish, so as to allow the fish to stand out, or by lighting up the 3-D figuring body 12, so as to enhance the design and craftsmanship of the 3-D figuring body 12.

It is worth mentioning that, the light enhancing arrangement 30 also helps to provide a correct temperature to the aquatic being 5 within the fantasia aquarium. Different aquatic beings 5 such as different types of fish can survive under different temperature environment. Some needs to live in slightly warmer temperature while others in slightly colder temperature.

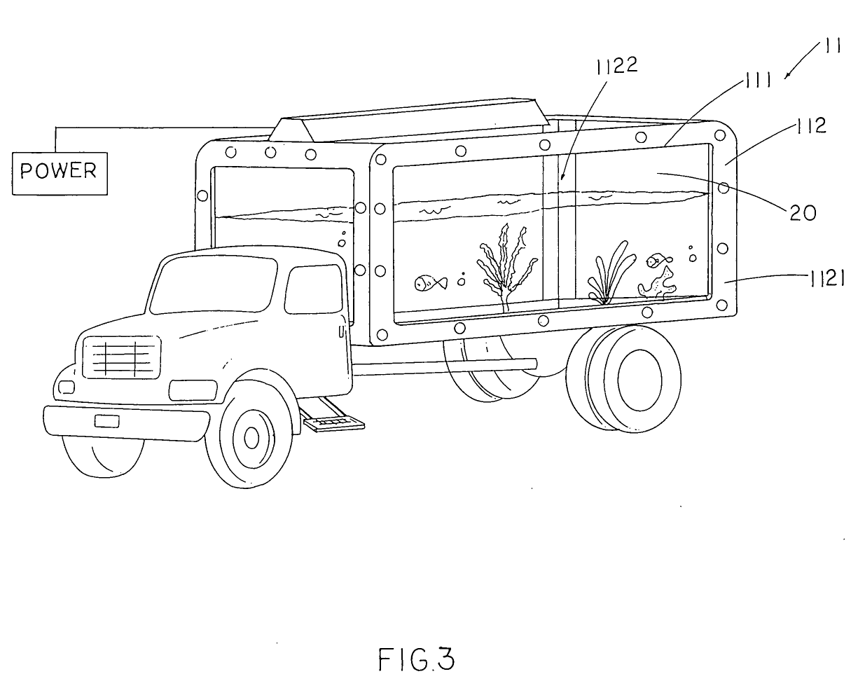

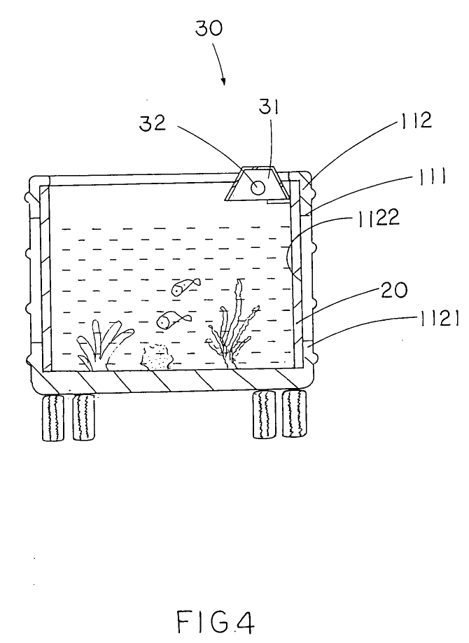

Referring to FIG. 3 and FIG. 4 of the drawings, alternatively, the sealing walls 20 do not have to be integrally provided at the display frame 11 to form. The displaying frame 11 comprises a plurality of boundary rims 112. Within the boundary rims 112 defined the viewing windows 111. And, in order to incorporate the sealing walls 20 on the displaying frame 11, the boundary rims 112 has an outer decorative side 1121 where the 3-D figuring body are formed, and an inner sealing side 1122 sealedly mounting the respective sealing walls 20 thereon.

Under this alternative, the 3-D figuring body 12 is also integrally protruded from the outer decorative sides 1121 of the displaying frame 11.

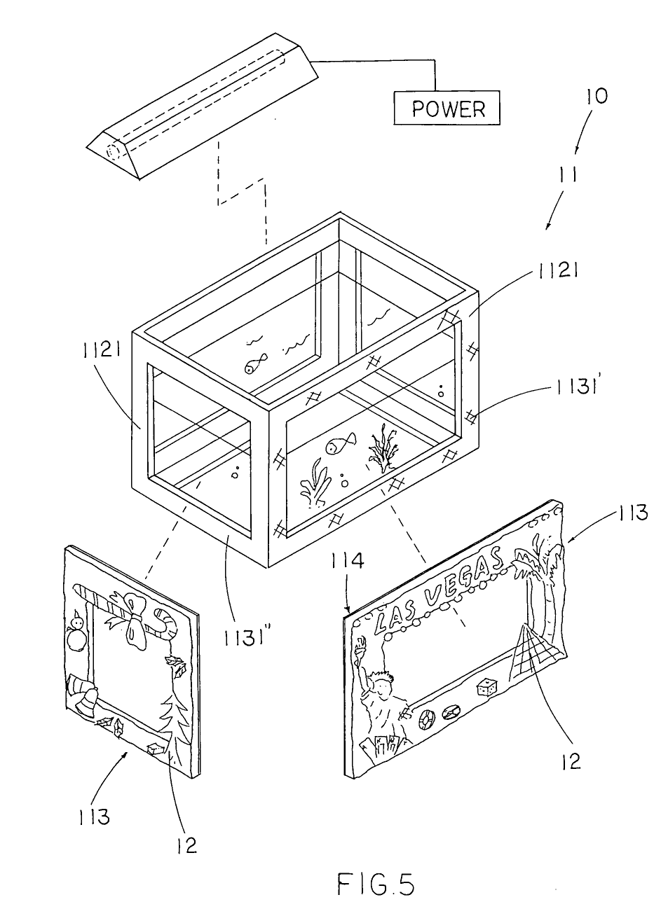

Referring to FIG. 5 of the drawings, however, the 3-D figuring body 12 can also not be integrally protruded from the outer decorative sides 1121 of the displaying frame 11. The displaying frame 11 further comprises a plurality of interchangeable faces 113, where on each of the plurality of interchangeable faces 113 has the 3-D figuring body 12 integrally protruded. And, in order to mount the interchangeable faces 113 onto the displaying frame 11, the interchangeable faces 113 also has a means for detechably mounting 1131 each of the interchangeable faces 113 on the outer decorative side 1121 of the displaying frame 11. The means helps retaining the 3-D figuring body 12 on the displaying frame in position.

The interchangeable faces allows the 3-D figuring body 12 on the displaying frame 11 to be changed, according to the mood of the owner or the decorations of the room.

The means for detechably mounting 1131 each of the interchangeable faces 113 on the outer decorative side 1121 of the displaying frame 11 can be an adhering layer 1131′ provided on an opposite side 114 to the interchangeable faces 113 to adhere the interchangeable faces 113 to the displaying frame 11, such that the interchangeable faces 113 can be attached to the displaying frame 11, according to the preference, taste and desire of the viewers.

Such a design will not only allow a easy fitting of the interchangeable faces 113 onto the displaying frame 11, the viewer can also easily replace the interchangeable faces 113 from one to another, allowing the fantasia aquarium to have different appearances, such that the viewer can change the appearance of the aquarium according to his or her mood or preference, or any festive season.

Alternatively, the means for detachably mounting 1131 each of the interchangeable faces 113 on the outer decorative side 1121 of the displaying frame 11 can be an adhering layer 1131′ provided on an inner side 114 to the interchangeable faces 113 to adhere the interchangeable faces 113 to the displaying frame 11, such that the interchangeable faces 113 can be attached to the displaying frame 11, according to the preference, taste and desire of the viewers

Alternatively, for detechably mounting 1131 each of the interchangeable faces 113 on the outer decorative side 1121 of the displaying frame 11 comprises two magnetic layers 1131″ provided the inner side 114 of each of the interchangeable faces 113 and the outer decorative side 1121 of the displaying frame 11 respectively. The two magnetic layers 1131″ are provided for each of the interchangeable faces 113 to magnetically mount on the outer decorative side 1121 of the displaying frame 113.

Conventional aquariums serve the simple function of displaying fish and providing a shelter to the fish therein. When conventional aquariums contain no fish, the aquariums would look empty, dull and pathetic. They could only serve as decorations when fish or other water creatures are placed therewithin.

In contrast, even when a fantasia aquarium under the present invention contains no fish, the fantasia aquarium itself has its own decorative value, since the 3-D figuring body 12 are incorporated to the frame 10. When the fantasia aquarium contains no fish, the 3-D figuring body 12 would take the focus of the viewer, such that the viewer will not pay attention to the emptiness of the plurality of see-through sealing walls 20.

As a result, the owner of such a fantasia aquarium does not have to worry about where to store and hide the fantasia aquarium when he/she decides to discontinue from keeping any fish in the fantasia aquarium. The fantasia aquarium could stand alone without any fish or water creatures inside to be a piece of decoration or art work to be appreciated.

Not only does the fantasia aquarium under the present invention have a decorative effect when the plurality of see-through sealing walls 20 is to be left empty, when water creatures are put within the container, it provides a theme to the water creatures.

Hence, it can be easily seen that the fantasia aquarium under the present invention not only serve as a decoration by itself, it also enhances the decorative effect of aquariums, such that when water creatures are placed inside the plurality of see-through sealing walls 20 of such a fantasia aquarium, they do not appear to be simply swimming inside a plain and boring tank. They would appear to be swimming inside a house, a castle or any theme that the fantasia aquarium provides.

It is worth mentioning that the structured frame 10′ is best to be made with water resistant material, such that the color and design of the structured frame 10′ will not be ruined by water, either water from the plurality of see-through sealing walls 20, or water from the cleaning of the fantasia aquarium. Furthermore, if the structured frame 10′ is also incorporated with decorations 12, the decorations 12 must best be water resistant, such as plastic or ceramics, so as to provide a longer life span of the fantasia aquarium.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A fantasia aquarium, comprising:
a characterizing building comprising a displaying frame having a plurality of viewing windows, and a sculpturally 3-D figuring body outwardly protruded from said displaying frame to create a 3-D figuring contour of said characterizing building; and
a plurality of see-through sealing walls sealedly provided on said displaying frame at said viewing windows respectively to form an aqua reservoir within said sealing walls that said aqua reservoir allows to be seen from outside through said viewing windows, wherein said characterizing building is 3-dimensionally custom-shaped for enhancing a fantasizing vision effect to create a virtual fantasia environment of said aqua reservoir for aquatic-being physically living therein.

2. The fantasia aquarium, as recited in claim 1, wherein said sealing walls are integrally provided at said displaying frame to form a one-piece integral structure of said characterizing building.

3. The fantasia aquarium, as recited in claim 1, wherein said 3-D figuring body is integrally protruded from said displaying frame to form an integral sculpturing structure.

4. The fantasia aquarium, as recited in claim 2, wherein said 3-D figuring body is integrally protruded from said displaying frame to form an integral sculpturing structure.

5. The fantasia aquarium, as recited in claim 1, wherein said characterizing building and said sealing walls are made of plexiglass.

6. The fantasia aquarium, as recited in claim 2, wherein said characterizing building and said sealing walls are made of plexiglass.

7. The fantasia aquarium, as recited in claim 3, wherein said characterizing building and said sealing walls are made of plexiglass.

8. The fantasia aquarium, as recited in claim 4, wherein said charactering body and said sealing walls are made of plexiglass.

9. The fantasia aquarium, as recited in claim 1, further comprising a light enhancing arrangement which comprises a light housing supported by said displaying frame and at least a light source received in said light housing to illuminate said aqua reservoir and to generate a light effect on said 3-D figuring body through said displaying frame.

10. The fantasia aquarium, as recited in claim 4, further comprising a light enhancing arrangement which comprises a light housing supported by said displaying frame and at least a light source received in said light housing to illuminate said aqua reservoir and to generate a light effect on said 3-D figuring body through said displaying frame.

11. The fantasia aquarium, as recited in claim 8, further comprising a light enhancing arrangement which comprises a light housing supported by said displaying frame and at least a light source received in said light housing to illuminate said aqua reservoir and to generate a light effect on said 3-D figuring body through said displaying frame.

12. The fantasia aquarium, as recited in claim 1, wherein said displaying frame comprises a plurality of boundary rims defining said viewing windows therewithin, wherein each of said boundary rims has an outer decorative side forming said 3-D figuring body thereon and an inner sealing side sealedly mounting said respective sealing wall thereon.

13. The fantasia aquarium, as recited in claim 12, wherein said 3-D figuring body is integrally protruded from said outer decorative sides of said displaying frame.

14. The fantasia aquarium, as recited in claim 13, further comprising a light enhancing arrangement which comprises a light housing supported by said displaying frame and at least a light source received in said light housing to illuminate said aqua reservoir and to generate a light effect on said 3-D figuring body through said displaying frame.

15. The fantasia aquarium, as recited in claim 12, wherein said displaying frame further comprises a plurality of interchangeable faces each having said 3-D figuring body integrally protruded therefrom and means for detachably mounting each of said interchangeable faces on said outer decorative side of said displaying frame to retain said 3-D figuring body on said displaying frame in position.

16. The fantasia aquarium, as recited in claim 15, further comprising a light enhancing arrangement which comprises a light housing supported by said displaying frame and at least a light source received in said light housing to illuminate said aqua reservoir and to generate a light effect on said 3-D figuring body through said displaying frame.

17. The fantasia aquarium, as recited in claim 15, wherein said mounting means comprises two magnetic layers provided on an inner side of each of said interchangeable faces and said outer decorative side of said displaying frame respectively such that each of said interchangeable faces is magnetically mounted on said outer decorative side of said displaying frame.

18. The fantasia aquarium, as recited in claim 16, wherein said mounting means comprises two magnetic layers provided on an inner side of each of said interchangeable face and said outer decorative side of said displaying frame respectively such that each of said interchangeable faces is magnetically mounted on said outer decorative side of said displaying frame.

19. The fantasia aquarium, as recited in claim 15, wherein said mounting means comprises an adhering layer provided on an inner side of each of said interchangeable face such that each of said interchangeable faces is replaceably adhered on said outer decorative side of said displaying frame.

20. The fantasia aquarium, as recited in claim 16, wherein said mounting means comprises an adhering layer provided on an inner side of each of said interchangeable face such that each of said interchangeable faces is replaceably adhered on said outer decorative side of said displaying frame.
